(19) United States
(12) Patent Application Publication
(10) Pub. No.: US 2026/0161804 A1
(43) Pub. Date: Jun. 11, 2026

(54) HYBRID SEQUESTERED COMPUTING

(71) Applicant: QUALCOMM Incorporated, San Diego, CA (US)

(72) Inventors: Bohuslav RYCHLIK, San Diego, CA (US); Engin IPEK, San Diego, CA (US); Hamza OMAR, San Diego, CA (US); Victor VAN DER VEEN, Leusden (NL); Brian KAHNE, Austin, TX (US)

(21) Appl. No.: 18/974,330

(22) Filed: Dec. 9, 2024

(51) Int. Cl. G06F 21/60; G06F 21/78

(52) U.S. Cl. CPC G06F 21/602; G06F 21/606; G06F 21/78

(57) ABSTRACT

Certain aspects of the present disclosure are directed towards an apparatus for private data processing. The apparatus generally includes: a decryption component configured to receive encrypted data and generate decrypted data based on the encrypted data, wherein the decrypted data is marked as being secret; and one or more processors coupled to the decryption component and configured to process the decrypted data while maintaining the mark of being secret to yield secret processed data.

### FIELD OF THE DISCLOSURE

Aspects of the present disclosure relate to artificial intelligence, and more particularly, techniques for providing data privacy.

### DESCRIPTION OF RELATED ART

Machine learning is generally the process of producing a trained model (e.g., an artificial neural network, a tree, or other structures), which represents a generalized fit to a set of training data that is known a priori. Applying the trained model to new data produces inferences, which may be used to gain insights into the new data. In some cases, applying the model to the new data is described as “running an inference” on the new data.

As the use of machine learning has proliferated for enabling various machine learning (or artificial intelligence) tasks, the need for more efficient processing of machine learning model data has arisen. In some cases, dedicated hardware, such as machine learning accelerators, may be used to enhance a processing system's capacity to process machine learning model data. However, such hardware requires space and power, which is not always available on the processing device. For example, “edge processing” devices, such as mobile devices, always on devices, internet of things (IoT) devices, and the like, have to balance processing capabilities with power and packaging constraints.

### BRIEF SUMMARY

Certain aspects of the present disclosure are directed towards an apparatus for private data processing. The apparatus generally includes: a decryption component configured to receive encrypted data and generate decrypted data based on the encrypted data, wherein the decrypted data is marked as being secret; and one or more processors coupled to the decryption component and configured to process the decrypted data while maintaining the mark of being secret to yield secret processed data.

Certain aspects of the present disclosure are directed towards a method for private data processing. The method generally includes: receiving, via a decryption component, encrypted data; generating, via the decryption component, decrypted data based on the encrypted data, wherein the decrypted data is marked as being secret; and processing, via one or more processors coupled to the decryption component, the decrypted data while maintaining the mark of being secret to yield secret processed data.

Certain aspects of the present disclosure are directed towards a data processing system. The data processing system may include: a client device configured to send a request for data processing, the request including encrypted data to be used for the data processing, and a server configured to: receive, via a decryption component, encrypted data included in the request and generate decrypted data based on the encrypted data, wherein the decrypted data is marked as being secret; and process, via one or more processors coupled to the decryption component, the decrypted data while maintaining the mark of being secret to yield secret processed data.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates a computing system for machine learning using a server.

FIG. 2 illustrates hybrid sequestered computing device, in accordance with certain aspects of the present disclosure.

FIG. 3 illustrates hybrid sequestered computing device with decryption and encryption of data from cache, in accordance with certain aspects of the present disclosure.

FIG. 4 illustrates a cloud processing system implemented with client-to-cloud privacy, in accordance with certain aspects of the present disclosure.

FIG. 5 is a flow diagram illustrating example operations for private data processing, in accordance with certain aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for providing data privacy for processing. In many cases, client devices may use computing power on a server (e.g., a cloud accelerator) to offload and accelerate computations. As one example, the server may run inferences using a machine learning model, although aspects of the present disclosure may be applied to provide data processing for any suitable data processing application. For example, a client device may send a request to the server, based on which the server may process some data (e.g., run an inference on a machine learning model) and respond to the client device with the processed data. Maintaining the privacy of communications between the client device and the server is important. For example, the client device may send sensitive user data to the server to data processing. User data communicated with the server may be encrypted for privacy. In addition to privacy for user data from client devices, the privacy of server implementations (e.g., a model for neural processing) is also important. Thus, data to be processed by the server may be encrypted. Some existing solutions for data privacy may involve trusting the software or firmware running on the server's cloud processor (e.g., accelerator). However, the software or firmware often ends up having security holes, resulting in privacy concerns. Some aspects are directed towards techniques for providing privacy of data communicated with and processed by the server, which may be performed even if the software or firmware running on the server is not trusted.

In some cases, homomorphic encryption may be used to encrypt data communicated with and processed by the server. However, homomorphic encryption drives up the computation burden (e.g., increased by a factor of 1000 to 10,000). As a result, homomorphic encryption may be impractical in many applications. Certain aspects of the present disclosure are directed towards techniques for enabling user private data to be processed safely in the Cloud with reduced computation burden as compared to conventional implementations. The ability to process data on a server with privacy may be important to entities such as semiconductor companies, Cloud service companies, or mobile operating service (OS) companies.

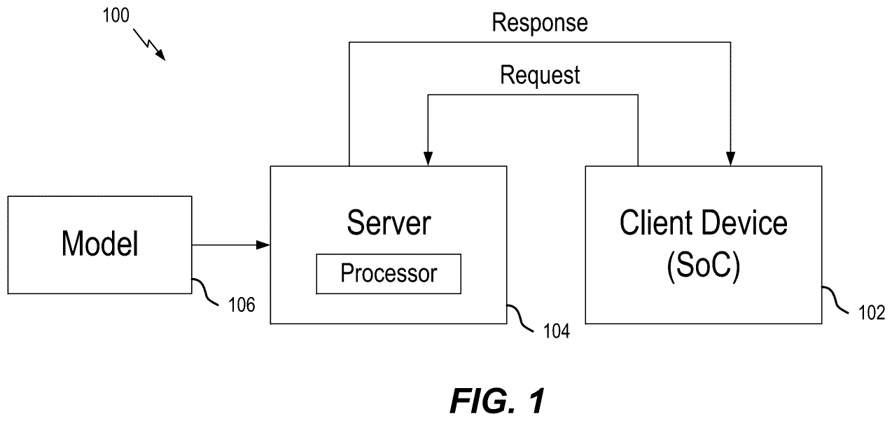

FIG. 1 illustrates a computing system 100 for machine learning using the Cloud. While some examples provided herein may be described with respect to artificial intelligence and machine learning to facilitate understanding, the aspects of the present disclosure may be used to provide privacy for any suitable application.

As shown, a system on chip (SoC) of a client device 102 may send a request to run an inference to server 104 using a model 106 stored on the server. The server 104 may include one or more processors such as a neural signal processor (NSP). While some examples provided herein are described with respect to an NSP to facilitate understanding, any suitable processor (or processors) may be used for neural processing. The one or more processors may run an inference per the request from the client device 102. For example, information sent as part of the request and information sent as a part of the response may be encrypted. As described, homomorphic encryption may be impractical due to the increased computing demand. In some cases, a sequestered encryption technique may be used that involves removing sensitive data from software-accessible architectures. For example, data may stay encrypted and only be decrypted before being provided to an arithmetic logic unit (ALU), and then encrypted after being processed by the ALU.

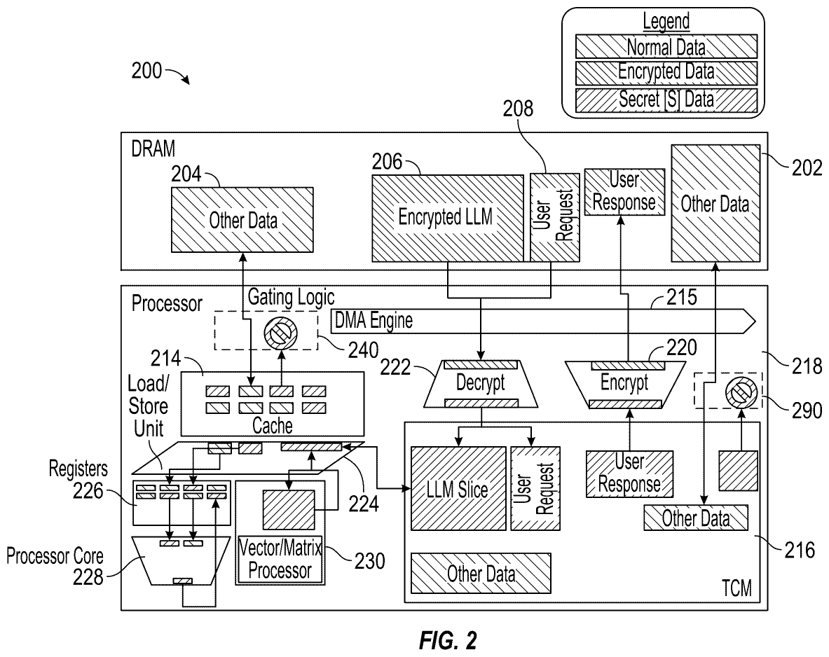

FIG. 2 illustrates hybrid sequestered computing device 200, in accordance with certain aspects of the present disclosure. The computing device 200 may be part of a server such as the server 104. As shown, the computing device 200 may include a memory 202 (e.g., dynamic random access memory (DRAM)) communicably coupled to a processor 218 such as an NSP. Elements of the processor 218 operate as a secret enclave. The processor 218 may be configured to track secret data (e.g., user data from the client device). The tracking of the secret data may be performed using a secret bit. For instance, the data may be a block of data (e.g., one or more bytes of data) and a bit of the block of data may be used to track whether the data is secret. However, while some examples provided herein may use a bit as part of the block of data to track whether the data is secret in some cases, any suitable technique for tracking whether a block of data is secret may be used, such as using metadata associated with the block of data. The secret classification of the data as tracked using a secret bit may follow the data as the data is moved (e.g., loaded/stored) and processed. In this manner, the classification of the data as being secret is not lost as the NSP processes the data.

As shown, the memory 202 may be used to save encrypted data 206, such as encrypted large language model (LLM) data from the client device, as well as an encrypted user request 208 from the client device. The encrypted data 206 and the encrypted user request 208 may be provided to a decryption component 222 using a direct memory access (DMA) engine 215. The encrypted data 206 and user request 208 may be decrypted and tagged as secret data. For example, each block of data may include a bit set to a logic value indicating that the data is secret. Thus, decryption operations generate secret data. The secret data may be stored in memory 216, which may be tightly coupled memory (TCM). As shown, other data (non-secret data, also referred to as normal data) may be also be stored in the memory 216. The other data may be received from the memory 202 through the DMA engine 215 without decryption. The other data may be any suitable data that may be used to fulfill the user request, such as data associated with an operating system for the client device.

As shown, the processor 218 may also include a load/store unit 224 that may be used to load/store secret or non-secret data between memory 216, cache 214, and/or one or more registers 226. The load/store unit 224 may propagate the secret bit in both directions (e.g., when storing data or loading data). Some aspects provide one or more instructions that may be used for loading or storing data. For example, a LOAD-SECRET instruction may load data and mark the data as secret, a STORE-SECRET instruction may store data and mark the data as secret, a LOAD-DECRYPT instruction may decrypt data on load, and a STORE-ENCRYPT instruction may encrypt data on store. These instructions may be generally referred to as LOAD/STORE-CRYPT instructions.

As shown, the load/store unit 224 may store secret and non-secret data in the registers 226 while tracking whether data is secret. For example, the data may be tracked as secret using a secret bit as described herein. In some cases, a portion of the registers 226 may be designated for secret data. Thus, LOAD-ENCRYPTED and STORE-ENCRYPTED may only target the subset of registers designated for secret data. No operations may be allowed to read from the secret registers while writing to an ordinary register to maintain the secret designation.

Non-secret control and data flow and other threads may execute normally from the registers 226. The registers 226 may be coupled to a processing core 228 (e.g., digital signal processor (DSP) or ALUs) for processing secret and non-secret data.

In some aspects, the processing core 228 may be implemented with data-flow inheritance. For example, the ALU output operand may inherit the secret bit from either input operand. Instructions with a secret bit operand produce a secret output. As an example, if secret data is multiplied with non-secret data, the resultant output data may be tagged as secret data using a secret bit. Similarly, instructions in shadow of a secret data-dependent control flow may generate secret data. For example, the execution of some instructions may depend on a secret condition. Consider a branch instruction following either a first code path at location A or a second code path at location B for execution. If the data input to the branch determining whether the first path or the second path is taken is tagged as secret, then the instructions for the first path and the second path are both control-flow dependent on the branch, and therefore in the shadow of a secret data dependent control flow. On the other hand, if the branch determines the first path or the second path independently of any secret data, then this represents a non-secret dependent control-flow. One example of the latter may be a branch controlling a loop. For example, suppose there is an operation that iterates over an array of 10 elements. Those elements may be secret or non-secret, but the loop iterating 10 times is not secret. Therefore, the branch controlling the loop is not tainted by any secret information and does not by itself taint as secret any instructions downstream of the branch. However, suppose whether the loop takes 5 or 10 iterations depends on secret data. In that case, all instructions downstream of the branch would be tainted as secret. Therefore, non-secret dependent control flow, non-secret data flow, and entirely non-secret threads may coexist with secret computations. As shown, the processor 218 may also include a vector/matrix processing core 230 that may be used to perform operations on secret and non-secret data while maintaining the secret bit from the input to the output of the core 230.

As shown, the load/store unit 224 may store/load secret and non-secret data to/from cache 214. While secret data may be allowed to be stored in cache 214, the secret data may not be allowed to be evicted from the cache without being encrypted. For example, gating logic 240 may be used to determine whether data being sent to the memory 202 is secret data. If so, the gating logic 240 may block the data from being sent to the memory 202. Other non-secret data 204 may be allowed to be provided to the memory 202. It should be noted that the computing device 200 may include various logic that are not shown in FIG. 2. For example, data may be routed to the memory 202 through other logic not shown.

In some cases, individual secret line eviction may not be supported, so line-by-line encryption may not be used. In some cases, individual secret line eviction may be implemented. If individual secret line eviction is used, software and hardware techniques such as partitioning and cache scrubbing may be implemented to avoid potential side-channel attacks.

Processed data, which may include secret and non-secret data, may be stored in memory 216. As shown, the processor 218 may also include an encryption component 220 and gating logic 290. The gating logic may check to ensure any secret data being sent to the memory 202 (e.g., an eventually back to the client device) is first encrypted using the encryption component 220. For example, the user response generated after running the inference based on the client device request may be encrypted and stored in the memory 202.

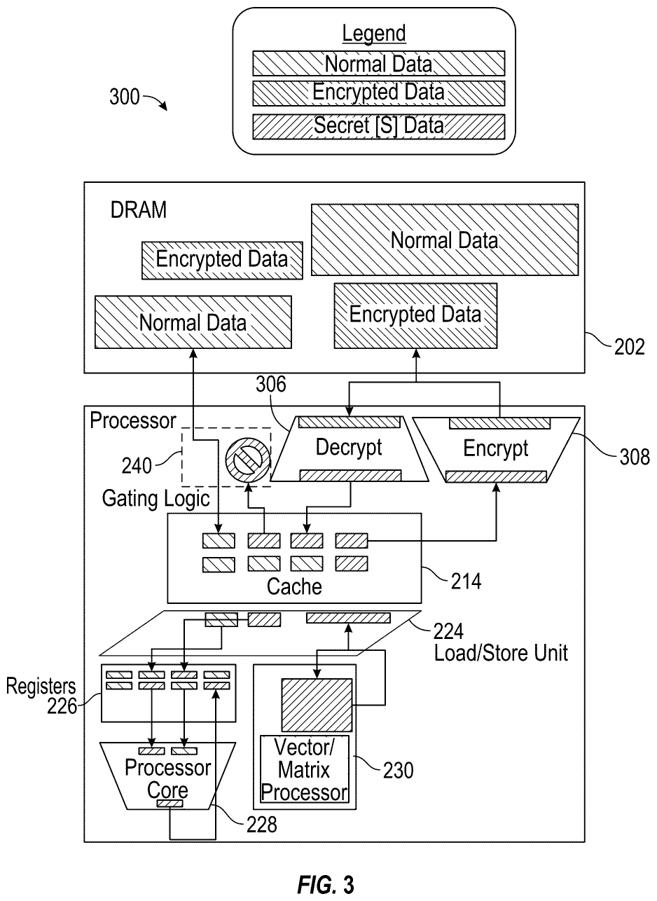

FIG. 3 illustrates hybrid sequestered computing device 300 with decryption and encryption of data from cache, in accordance with certain aspects of the present disclosure. The computing device 300 may be implemented with a decryption component 306 and an encryption component 308 between the cache 214 and the memory 202. Thus, secret data from the cache may be routed to the memory 202 through the encryption component 308 and encrypted data from the memory 202 may be decrypted through the decryption component 306, tagged as secret, and stored in the cache 214. As described, gating logic 240 may prevent any secret data from being provided to the memory 202 without encryption via the encryption component 308. To encrypt cacheline evictions, locations in memory that are encrypted may be tracked. For example, a metadata tracking table may be implemented in memory. In some cases, the metadata tracking table may be cached. In some cases, page-level tracking may be used, which may result in all evictions to that page of cache to be either encrypted or not be encrypted. As described, software may use STORE-ENCRYPT/LOAD-DECRYPT instructions for the stack push/pop (e.g., used to main a stack in memory where function call arguments and local variables are stored). However, a LOAD-DECRYPT instruction may receive information indicating whether the data being decrypted is secret. This metadata could be kept on the stack as well. In some cases, a STORE-EXFILTRATE instruction may be used to allow secret data to be written out, although this may cause security holes.

Some software stacks may support compiler-generated register spills and fills of a mixture of normal and secret data in registers. Register spilling occurs whenever the register allocator runs out of registers, and therefore “spills” values by saving and restoring them from memory. To support register spills and fills of a mixture of normal and secret data in registers, a vector stack may be implemented in the memory 216 for vector extension data. The compiler may spill vector extension registers to the vector stack. Many machine learning control codes are data independent, meaning scalar codes may not be tainted and continue using the standard cache-based memory stack. In some cases, special LOAD/STORE-CRYPT instructions may be used. For example, with a STORE-CRYPT instruction, if caching of secret data is allowed, the data may be written in cache and the associated cache line may be tainted (tagged) as secret. Hardware such as the gating logic may be used to check that evictions from cache or uncached writes of secret data are encrypted (e.g., via encryption component 308) before being written to the SoC bus/memory. With a LOAD-CRYPT instruction, if caching secret data is allowed, data loaded from cache and stored in a register may be marked as secret. Hardware may be used to check that cache allocations or uncached reads are decrypted and tainted as secret in cache and registers. Software may be used to determine which processes are computing on potentially secret data and choose to use STORE/LOAD-CRYPT to save/restore such data. Otherwise, software can use ordinary LOAD/STORE on normal data. When it is unclear whether data is secret or normal, the software may default to using STORE/LOAD-CRYPT instructions. This feature may be important for more complex models where control codes may be used to select which models to run based on data from prior model executions.

In some cases, normal and secret data may share a cacheline. To reduce the over-tagging of data as secret, one or more processors (e.g., via software) may be used to separate out secret and normal data cachelines. In other words, normal and secret data stacks and heaps may be maintained and used to implement separate regions of cache for secret data and non-secret data. Thus, software may be aware of cacheline granularity to separate out secret and normal data cachelines.

In some aspects, sub-cache line secret data tracking may be maintained. For example, software or hardware may be used to store individual secret bit metadata for each cacheline in memory. The location of secret data may be derivable from cleartext metadata.

In some aspects, one or more measures may be taken to reduce the probability of side-channel attacks on data in the cache. For example, secret data may be always uncached. As another example, software may be used to provide secret/data-independent use/allocation in cache. That is, if the cache allocation is never dependent on secret data, then an observer cannot deduce the secret data even if the observer can indirectly detect the allocation. Detection of other processes' cache allocation is a way side-channel attacks steal secrets, using the cache performance behavior as a side channel. In some cases, a special partition for secret data in cache may be provided with pre/post cache scrubbing software.

In some cases, multiple secret bits may be used, where each bit is associated with a different source of data. For example, the server may receive data from different sources. It is important to ensure that private data from one source is not leaked to another source. Thus, the multiple secret bits may be used to track which source a particular set of data is from. In some cases, each secret bit may be associated with a different encryption key. For example, data from a client device may be encrypted using a key that other sources of data (e.g., other client devices) do not have so that only the client device can decrypt the data. Thus, multiple secret bits can be used to differentiate multiple users or requests from clients. Different secret bits would map to different encryption keys so that one concurrent user could not observe the data or results of another user.

Note that these techniques could also be applied not just across the Cloud, but entirely within a single system or SoC. For example, a laptop running multiple processes from different users could use this technique to prevent leakage of data from one process to another without relying on perfect memory partitioning and OS correctness

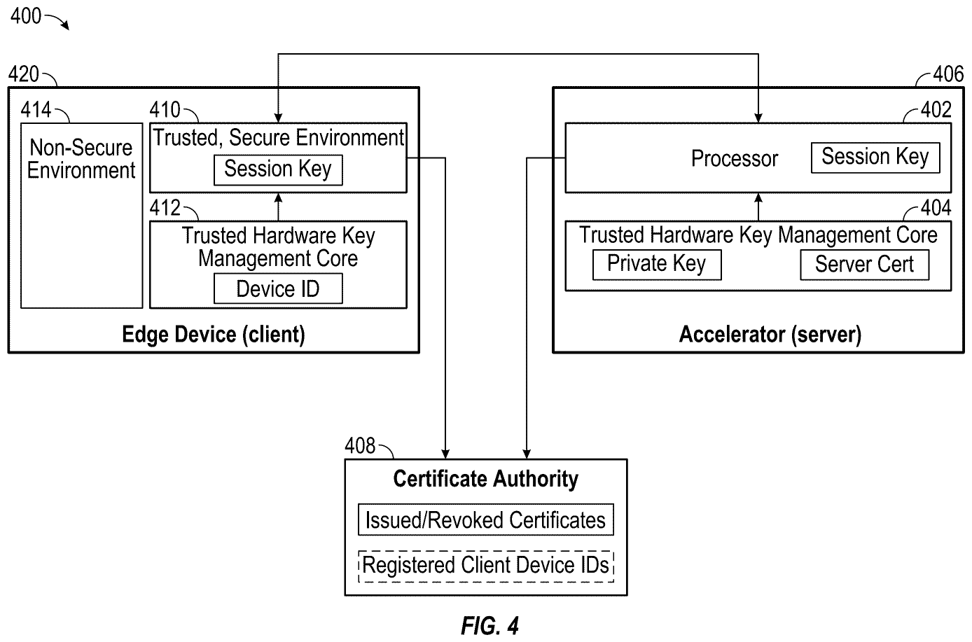

FIG. 4 illustrates a cloud processing system 400 implemented with client-to-cloud privacy, in accordance with certain aspects of the present disclosure. In some cases, the client and server devices such as the server 406 (e.g., accelerator) and the client device 420 (e.g., edge device) are both for the same vendor or include SoCs for the same vendor. In this case, the vendor may be able to provide privacy end-to-end without any dependencies on client device original equipment manufacturer (OEM), client device operating system (OS) vendor, cellular and internet service provider, cloud service providers, cloud host server OEMs, cloud host CPU vendors, cloud OS vendors, or standards bodies. That is, the vendor may manage the vendor's own private key distribution between the client device SoC and Cloud SoC.

The client SoC and Cloud SoC may use private keys to establish a key for a secure communication channel. Certain aspects of the present disclosure have provided techniques for preventing communications from exiting a processor for neural processing in the Cloud SoC without being encrypted by this key. Thus, only the processor of the client SoC may be able to decrypt the response, establishing an end-to-end vendor-guaranteed enclave, as described in more detail herein. In this manner, privacy can be provided for intellectual property (IP) protection to protect a machine learning model's weights, protect the integrity of a model so no surreptitious modification of a model's weights occurs, and protect confidential user data (e.g., activations) from observation even if the operating system (OS) on the application cores has been compromised.

Any suitable technique may be used to set up a session key for communication between the client device and the server, such as a transport layer security (TLS) handshake. As shown, the server 406 may include a processor 402 (e.g., NSP) coupled to a trusted hardware key management core 404 that may store a private key and a server certificate. The client device may include a non-secure environment 414 (e.g., non-secure processing circuitry), a trusted and secure environment 410 (e.g., secure processing circuitry), and a trusted hard key management core 412 that may store a device ID for the client device 420.

A trusted software environment (e.g., a trusted application running on a trusted execution environment, such as the trusted and secure environment 410) on the client device 420 (e.g., edge device) may connect to the processor 402 (e.g., NSP) running on the server 406 (e.g., accelerator) and initiate a TLS handshake. As part of the TLS handshake, the server 406 may send the server's certificate signed by a certificate authority (CA) 408 back to the client. As part of the TLS handshake, the client device 420 contacts the CA 408 to confirm that the server certificate is valid and has not been revoked. To finalize the TLS handshake, the client device 420 may generate a session key and send the key to the server. The TLS handshake is now completed, and a secure connection between the trusted, secure environment on the client device and the processor on the server has been established. In some cases, the client device may encrypt the client device's ID using the session key and send the encrypted device ID to the server. The server may verify with the CA that the client's device ID is registered and valid. The server may then accept the client and respond that the server is ready to receive requests.

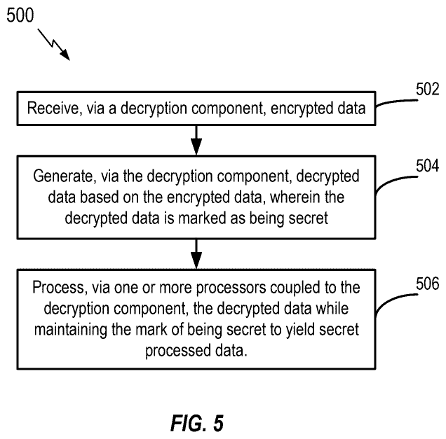

FIG. 5 is a flow diagram illustrating example operations 500 for private data processing, in accordance with certain aspects of the present disclosure. The operations 500 may be performed by a computing device, such as the computing device 200 of FIG. 2 or the computing device 300 of FIG. 3.

At block 502, the computing device may receive, via a decryption component (e.g., decryption component 222 or decryption component 306) encrypted data, and at block 504, generate decrypted data based on the encrypted data. The decrypted data is marked as being secret. In some aspects, the decrypted data may include a data block with a bit to mark the data block as secret.

At block 506, the computing device may process, via one or more processors (e.g., processor 230 or processing core 228) coupled to the decryption component, the decrypted data while maintaining the mark of being secret to yield secret processed data.

In some aspects, the computing device may receive, via an encryption component (e.g., encryption component 220, 308), the secret processed data and generate encrypted processed data based on the secret processed data. The decryption component may receive the encrypted data loaded from memory (e.g., memory 202) and the encryption component may output the encrypted processed data to be stored in the memory.

In some aspects, the computing device may block, via gating logic (e.g., gating logic 240), data from being routed to one or more other components (e.g., memory 202) without encryption if the data is marked as secret. The computing device may allow other data to be routed to the one or more other components if the other data is not marked as secret. For example, the computing device may be an SoC, and the one or more other components ma be external to the SoC.

In some aspects, to process the decryption data, the one or more processors may perform an operation (e.g., an arithmetic operation) on the decryption data with non-secret data while maintaining the mark of being secret to yield the secret processed data. The computing device may load and store (e.g., via the load and store unit 224), the decrypted data while propagating the marking that the decrypted data is secret.

In some aspects, the computing device may store, via memory (e.g., memory 218), the decrypted data marked as secret. The load and store unit may load the decrypted data with the marking that the decrypted data is secret and store the decrypted data in one or more registers (e.g., one or more registers 226) with the marking that the decrypted data is secret. The one or more processors may process the decrypted data from the one or more registers.

In some aspects, the load and store unit may store at least one of the decrypted data or the secret processed data in a line of the cache. The line of the cache may be marked as being secret. In some aspects, the cache may include a first region for storing secret data and a second region for storing non-secret data. The decrypted data and/or the secret processed data may be stored in the first region.

In some aspects, the encrypted data may be received from an external device, where the computing device and the external device are associated with the same vendor. The computing device may perform a security protocol directly with the external device to yield a session key to be used to generate the encrypted data.

In some aspects, the decrypted data may be marked as being secret using multiple bits, each bit corresponding to a different data source. The encrypted data may be encrypted using one of a plurality of encryption keys. Each of the multiple bits may be associated with a respective one of the plurality of encryption keys. For example, certain aspects may use multiple distinct bits for each client, and accumulate the bits through inheritance. A decision may be made regarding which key or keys may be used to encrypt the data to be sent back to the client or clients. A multi-bit secret tag with an ID may be used to identify the client. An operation that combines a secret input from two different clients may be considered an error condition, and an interrupt or halt may be triggered accordingly.

In some cases, the decrypted data may include at least one of a request to run an inference using a machine learning model or data associated with running the inference. The computing device may be part of a server to run the inference in accordance with the request.

### EXAMPLE CLAUSES

Implementation details of various aspects of the present disclosure are described in the following numbered clauses.

Aspect 1: An apparatus for private data processing, comprising: a decryption component configured to receive encrypted data and generate decrypted data based on the encrypted data, wherein the decrypted data is marked as being secret; and one or more processors coupled to the decryption component and configured to process the decrypted data while maintaining the mark of being secret to yield secret processed data.

Aspect 2: The apparatus of Aspect 1, wherein the decrypted data comprises a data block with a bit to mark the data block as secret.

Aspect 3: The apparatus of Aspect 1 or 2, further comprising an encryption component configured to receive the secret processed data and generate encrypted processed data based on the secret processed data.

Aspect 4: The apparatus of Aspect 3, wherein: the decryption component is configured to receive the encrypted data loaded from memory; and the encryption component is configured to output the encrypted processed data to be stored in the memory.

Aspect 5: The apparatus according to any of Aspects 1-4, further comprising gating logic configured to: block data from being routed to one or more other components without encryption if the data is marked as secret; and allow other data to be routed to the one or more other components if the other data is not marked as secret.

Aspect 6: The apparatus of Aspect 5, wherein the apparatus is configured as a system on chip, and wherein the one or more other components are external to the system on chip.

Aspect 7: The apparatus according to any of Aspects 1-6, wherein, to process the decryption data, the one or more processors are configured to perform an operation on the decryption data with non-secret data while maintaining the mark of being secret to yield the secret processed data.

Aspect 8: The apparatus according to any of Aspects 1-7, further comprising load and store unit configured to load and store the decrypted data while propagating the marking that the decrypted data is secret.

Aspect 9: The apparatus according to any of Aspects 1-8, further comprising: memory configured to store the decrypted data marked as secret; and a load and store unit is configured to: load the decrypted data with the marking that the decrypted data is secret; and store the decrypted data in one or more registers with the marking that the decrypted data is secret, the one or more processors being configured to process the decrypted data from the one or more registers.

Aspect 10: The apparatus according to any of Aspects 1-9, further comprising: cache; and a load and store unit configured to store at least one of the decrypted data or the secret processed data in a line of the cache, wherein the line of the cache is marked as being secret.

Aspect 11: The apparatus of Aspect 10, wherein the cache includes a first region for storing secret data and a second region for storing non-secret data, wherein the at least one of the decrypted data or the secret processed data is stored in the first region.

Aspect 12: The apparatus according to any of Aspects 1-11, wherein the encrypted data is received from an external device, and wherein the apparatus and the external device are associated with the same vendor.

Aspect 13: The apparatus of Aspect 12, wherein the apparatus is configured to perform a security protocol directly with the external device to yield a session key to be used to generate the encrypted data.

Aspect 14: The apparatus according to any of Aspects 1-13, wherein the decrypted data is marked as being secret using multiple bits, each bit corresponding to a different data source.

Aspect 15: The apparatus of Aspect 14, wherein the encrypted data is encrypted using one of a plurality of encryption keys, and wherein each of the multiple bits is associated with a respective one of the plurality of encryption keys.

Aspect 16: The apparatus according to any of Aspects 1-15, wherein the decrypted data comprises at least one of a request to run an inference using a machine learning model or data associated with running the inference.

Aspect 17: The apparatus of Aspect 16, wherein the apparatus is part of a server configured to run the inference in accordance with the request.

Aspect 18: A method for private data processing, comprising: receiving, via a decryption component, encrypted data; generating, via the decryption component, decrypted data based on the encrypted data, wherein the decrypted data is marked as being secret; and processing, via one or more processors coupled to the decryption component, the decrypted data while maintaining the mark of being secret to yield secret processed data.

Aspect 19: The method of Aspect 18, wherein the decrypted data comprises a data block with a bit to mark the data block as secret.

Aspect 20: A data processing system, comprising: a client device configured to send a request for data processing, the request including encrypted data to be used for the data processing; and a server configured to: receive, via a decryption component, encrypted data included in the request and generate decrypted data based on the encrypted data, wherein the decrypted data is marked as being secret; and process, via one or more processors coupled to the decryption component, the decrypted data while maintaining the mark of being secret to yield secret processed data.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for private data processing, comprising:
a decryption component configured to receive encrypted data and generate decrypted data based on the encrypted data, wherein the decrypted data is marked as being secret; and
one or more processors coupled to the decryption component and configured to process the decrypted data while maintaining the mark of being secret to yield secret processed data.

2. The apparatus of claim 1, wherein the decrypted data comprises a data block with a bit to mark the data block as secret.

3. The apparatus of claim 1, further comprising an encryption component configured to receive the secret processed data and generate encrypted processed data based on the secret processed data.

4. The apparatus of claim 3, wherein:
the decryption component is configured to receive the encrypted data loaded from memory; and
the encryption component is configured to output the encrypted processed data to be stored in the memory.

5. The apparatus of claim 1, further comprising gating logic configured to:
block data from being routed to one or more other components without encryption if the data is marked as secret; and
allow other data to be routed to the one or more other components if the other data is not marked as secret.

6. The apparatus of claim 5, wherein the apparatus is configured as a system on chip, and wherein the one or more other components are external to the system on chip.

7. The apparatus of claim 1, wherein, to process the decryption data, the one or more processors are configured to perform an operation on the decryption data with non-secret data while maintaining the mark of being secret to yield the secret processed data.

8. The apparatus of claim 1, further comprising load and store unit configured to load and store the decrypted data while propagating the marking that the decrypted data is secret.

9. The apparatus of claim 1, further comprising:
memory configured to store the decrypted data marked as secret; and
a load and store unit is configured to:
load the decrypted data with the marking that the decrypted data is secret; and
store the decrypted data in one or more registers with the marking that the decrypted data is secret, the one or more processors being configured to process the decrypted data from the one or more registers.

10. The apparatus of claim 1, further comprising:
cache; and
a load and store unit configured to store at least one of the decrypted data or the secret processed data in a line of the cache, wherein the line of the cache is marked as being secret.

11. The apparatus of claim 10, wherein the cache includes a first region for storing secret data and a second region for storing non-secret data, wherein the at least one of the decrypted data or the secret processed data is stored in the first region.

12. The apparatus of claim 1, wherein the encrypted data is received from an external device, and wherein the apparatus and the external device are associated with the same vendor.

13. The apparatus of claim 12, wherein the apparatus is configured to perform a security protocol directly with the external device to yield a session key to be used to generate the encrypted data.

14. The apparatus of claim 1, wherein the decrypted data is marked as being secret using multiple bits, each bit corresponding to a different data source.

15. The apparatus of claim 14, wherein the encrypted data is encrypted using one of a plurality of encryption keys, and wherein each of the multiple bits is associated with a respective one of the plurality of encryption keys.

16. The apparatus of claim 1, wherein the decrypted data comprises at least one of a request to run an inference using a machine learning model or data associated with running the inference.

17. The apparatus of claim 16, wherein the apparatus is part of a server configured to run the inference in accordance with the request.

18. A method for private data processing, comprising:
receiving, via a decryption component, encrypted data;
generating, via the decryption component, decrypted data based on the encrypted data, wherein the decrypted data is marked as being secret; and
processing, via one or more processors coupled to the decryption component, the decrypted data while maintaining the mark of being secret to yield secret processed data.

19. The method of claim 18, wherein the decrypted data comprises a data block with a bit to mark the data block as secret.

20. A data processing system, comprising:
a client device configured to send a request for data processing, the request including encrypted data to be used for the data processing; and
a server configured to:
receive, via a decryption component, encrypted data included in the request and generate decrypted data based on the encrypted data, wherein the decrypted data is marked as being secret; and
process, via one or more processors coupled to the decryption component, the decrypted data while maintaining the mark of being secret to yield secret processed data.
